(19) United States
(12) Patent Application Publication
(10) Pub. No.: US 2005/0254125 A1
(43) Pub. Date: Nov. 17, 2005

(54) Telescope power switch

(76) Inventors: Russell Drew Lederman, Berlin, MD (US); Clamore William Dankmeyer, Berlin, MD (US)

Correspondence Address: LAWRENCE EDELMAN, ESQ, 3 BUFFALO RUN, EAST BRUNSWICK, NJ, 08816, US

(21) Appl. No.: 11/130,714

(22) Filed: May 17, 2005

Related U.S. Application Data
(60) Provisional application No. 60/571,592, filed on May 17, 2004.

(51) Int. Cl. G02B 23/00

(52) U.S. Cl. 359/399; 359/406

(57) ABSTRACT

A magnification changing system for a telescope, comprising a housing having a lightpath therethrough, which lightpath is adapted to be positioned in alignment with the lightpath of the telescope. The housing includes a movable portion for selectively positioning into and out of the lightpath of the housing at least one optical element. Movement of the movable portion selectively places the optical element into and out of a position coincident with the lightpath of the telescope, thereby selectively changing the effective focal length, and hence the magnification, of the telescope. In a preferred embodiment, the housing comprises a star diagonal, having the movable portion integrated on the telescope side of the housing, eyepiece side of the housing, or both sides of the housing.

### CROSS-REFERENCE TO RELATED APPLICATIONS

This application claims priority under 35USC 120 of U.S. Provisional Patent Application No. 60/571,592 filed May 17, 2004, entitled “Variable Magnification Systems For Telescopes”. The entire disclosure of this patent application is incorporated herein by reference in its entirety.

### BACKGROUND OF THE INVENTION

1. Field of the Invention

The present invention relates to an apparatus for changing the amount of magnification provided in a telescope without changing the eyepiece, and more specifically, to a multi-purpose, modular, optical switching system that can be used with several different types of telescopes, which allows the user of the telescope to quickly, reliably and easily change the magnification of the telescope without changing the eyepiece.

2. Description of the Prior Art

When using a telescope, the eyepiece is normally what determines magnification factors when used in combination with the telescope optical system. A short focal length eyepiece, such as one with a 5 mm focal length, would typically render views of objects that are highly magnified. An eyepiece with a longer focal length (e.g., 32 mm) would create lower power views. Thus, when an eyepiece focal length is divided into the effective focal length of a telescope, the magnification of the eyepiece can be derived. Therefore, increasing or decreasing the effective focal length of the telescope will change the magnification of an eyepiece having a given focal length. Because observers like to view individual objects at varying magnifications to examine sections under high magnification, and also view the entire object at once with low magnification, the exchange of eyepieces is the most usual process undertaken for accomplishing this. However, the exchanging of eyepieces can be a bit cumbersome since telescopes are conventionally used in the dark, and even further, exchanging of eyepieces is also time consuming. An object that is viewed at very low power and then after exchanging eyepieces is viewed at high power, may even be absent from the high power field of view, and would need to be relocated. The expense of using many eyepieces is also an important consideration when weighing the disadvantage of the current state of the art.

It would be a desirable, as well as an economic approach to the goal of allowing high and low power views, to have a system which would allow one eyepiece to operate at several magnifications. The ease of changing magnifications by use of such a system would an important consideration, since it would make astronomy more fun and also more productive because time would not be spent fiddling with equipment, but observing. It would also be desirable to be able to incorporate such a magnification change system into a star diagonal of the type typically using in telescopes.

### OBJECTS OF THE INVENTION

Therefore, it is an object of the present invention to provide a means by which a variety of magnifications, specifically two or more, can be obtained instantly without exchanging eyepieces in an astronomical or terrestrial telescope. It is a further object of the invention to provide a means to increase or decrease the effective focal length of the telescope. It is an even further object of the invention to provide a means by which focal reduction may be obtained in an astronomical telescope with less demand for backfocus as compared to conventional prior art methods. Even furthermore, the present invention provides a means to allow varying magnifications for a camera or other optical device used with a telescope. It is an even further object of the invention to integrate the elements of the variable magnification apparatus of the present invention with an angled viewing element, such as a star diagonal.

### SUMMARY OF THE INVENTION

The present invention provides a housing having a lightpath therethrough, which lightpath is adapted to be positioned in alignment with the lightpath of a telescope. The housing includes a movable portion for selectively positioning into and out of the lightpath of the housing at least one optical element. Accordingly, movement of the movable portion selectively places the optical element into and out of a position coincident with the lightpath of the telescope, thereby selectively changing the magnification of the telescope.

Furthermore, the housing of the present invention is particularly well suited for being embodied (e.g., integrated) with a star diagonal, as well as for use in either a Refractor or Schmidt Cassegrain Telescope (SCT). Even furthermore, due to the modularity of the present invention, depending on the particular result desired and the type of telescope being used, the lens switching housing of the invention can be used on either the telescope focus tube side or the eyepiece side of the star diagonal, or both sides simultaneously, in accordance with the results desired by the user.

Since the present invention includes in one embodiment a focal reducer lens with the moveable portion, the invention allows a user of an SCT telescope the ability to eliminate the process of threading a focal reducing lens onto the visual back of the SCT telescope, a process known to those familiar in the art of amateur astronomy. In order to currently use a focal reducer such as that marketed by Celestron International or Meade Corporation, one must begin by removing the eyepiece, removing the star diagonal, threading the focal reducer to the rear threads of the SCT visual back, replacing the star diagonal, and replacing the eyepiece, and then refocusing the telescope. With the lens switching system of the present invention, one simply moves the moveable portion that contains the lens, so as to thereby introduce the optical reducer into the lightpath. Nothing is removed. The telescope only needs to be refocused. If the observer then wishes to remove the focal reduction factor, that portion of the housing containing the reducing optic is moved out of the light path. It should be noted that the optical components utilized in the invention may be introduced or removed from the optical path of the telescope by a variety of means such as sliding holders or a circular disc that when rotated places an optical element or an aperture with no optical element, into a position that is coincident with said optical path created by the telescope. It should also be noted that a variety of optical lenses can be used as part of the invention, such as focal reducers, telenegative multipliers, etc., all having varying focal lengths and therefore, magnification factors.

It must also be noted that the lens switching system of the invention may be placed on the eyepiece-side of said star diagonal instead of telescope side so that an SCT user may allow a binocular viewer to achieve multi-magnification use. If the lens switching device (moveable portion of the invention) contains a positive lens (e.g., +250) and a negative lens (e.g., −150), a binocular viewer will operate at a reduced magnification (e.g., F/6), a normal magnification (unit power) and a multiplied magnification (e.g., 2×). These magnifications can be implanted by a variety of means that allow the optical components to be alternatively placed in or removed from the light path of the telescope.

In accordance with an even further embodiment of the present invention, a star diagonal is equipped with both a telescope-side and eyepiece-side lens switching device as described above, thereby becoming extremely versatile in terms of operating for either a single eyepiece (that is, without a binocular viewer) or with a binocular viewer, for use on both SCT and refractor type telescopes. In the case of a refractor telescope, the telescope-side switching device can be equipped with two negative lenses of varying focal length. The eyepiece-side can be equipped with a positive and negative lens of varying focal lengths. If the telescope-side device contains a −150 and −200, and the eyepiece side contains a −200 and +250, seven different magnifications are possible when using any single eyepiece. See for example, the Table 1 below, where TS=telescope-side and ES=eyepiece-side:

TABLE 1
Refractor Telescope
Single Eyepiece Use

| | |
|---|---|
| TS −150/ES 0 | Produces Multiplication |
| TS −150/ES −200 | Produces Multiplication |
| TS −200/ES −200 | Produces Multiplication |
| TS 0/ES −200 | Produces Multiplication |
| TS 0/ ES 0 | For Normal Unit Magnification. |
| TS 0/ ES +250 | Reduced Magnification |
| TS −200/ES 0 | Produces Multiplication |

This system can also allow for focal plane relay when using a binocular viewer and can provide 6 different magnification factors with any eyepiece pair, as shown by Table 2 below:

TABLE 2
Refractor Telescope
Binocular Viewer Use

| | |
|---|---|
| TS −200/ES +250 | Relays focal plane with very little magnification gain |
| TS −150/ES +250 | Relays focal plane with moderate magnification gain |
| TS −200/ES 0 | Relays focal Plane with moderate-high magnification |
| TS −150/ES 0 | Relays focal plane with high magnification |
| TS −200/ES −200 | Relays focal plane with additional-high magnification |
| TS −150/ES −200 | Relays focal plane with highest magnification |

When two such lens-switching systems are used on an SCT, a single eyepiece may be used with maximum focal reduction and amplification when the telescope-side switch is used, or, when an eyepiece-side switch equipped with a positive and negative optic is used, it will allow a binocular viewer to operate at focal reduction, normal and high magnifications as well. The telescope-side negatives and the eyepiece-side positive may also be used simultaneously to allow for relay of the focal plane rather than moving the SCT primary by way of focuser rotation. This allows single eyepiece use and binoviewer use to be parfocal. This may be important when users desire to use Crayford or other type of focusers rather than the typical SCT focusing mechanism. The importance of not using the typical focuser on an SCT involves control and mitigation of mirror shift and spherical aberration, known to those familiar in the art of SCT use. An example of different magnification factors available with a single eyepiece for SCT use is shown by Table 3, and an example of different magnification factors available with a binocular viewer for SCT use is shown by Table 4.

TABLE 3
SCT Use
Single eyepiece

| | |
|---|---|
| TS −150/ES 0 | Magnification |
| TS −150/ES −200 | Maximum High Magnification |
| TS +250/ES +250 | Extreme Focal Reduction |
| TS +250/ES 0 | Focal Reduction |
| TS 0/ES +250 | Moderate Focal Reduction |
| TS 0/ES −200 | Moderate Magnification |
| TS 0/ES 0 | Normal Magnification |
| TS −150/ES +250 | Focal Plane Relay for Camera |

TABLE 4
SCT Use
Binocular Viewer Use

| | |
|---|---|
| TS −150/ES 0 | Magnification |
| TS −150/ES −200 | Maximum High Magnification |
| TS +250/ES 0 | Maximum Focal Reduction |
| TS 0/ES +250 | Focal Reduction |
| TS 0/ES −200 | Moderate Magnification |
| TS 0/ES 0 | Normal Magnification |
| TS −150/ES +250 | Focal Plane is Relayed instead of need |
| | for Primary mirror |
| | movement |

As noted above, the lens-switching system of the invention can be integrated with an angled-optical device, such as a star diagonal, may include one of both of the eyepiece-side and telescope-side lens-switching devices.

### BRIEF DESCRIPTIONS OF THE DRAWINGS

The accompanying drawings, which are incorporated herein and constitute part of this specification, illustrate preferred and alternative embodiments and details of the invention, and together with the general description given above and the detailed description given below, serve to further explain various features of the invention.

FIG. 1 generally illustrates a first embodiment of an optical system constructed and operating in accordance with the principles of the invention.

FIG. 2 illustrates a further embodiment of an optical system in accordance with the principles of the invention where the optical system of FIG. 1 is integrated with a star diagonal.

FIG. 3 illustrates an embodiment accordance with the principles of the invention where an alternative embodiment of the optical system of FIG. 1 is integrated with a star diagonal.

FIG. 4 illustrates a variation of the inventive optical system shown in FIG. 2, where the optical system of FIG. 1 is integrated on the eyepiece-side of the star diagonal, as compared with the telescope-side of the star diagonal as shown in FIG. 2.

FIG. 5 illustrates a further variation of the inventive optical system shown in FIG. 2, where the optical system of FIG. 1 is integrated on the eyepiece-side and telescope-side of the star diagonal.

### DETAILED DESCRIPTION OF THE PREFERRED EMBODIMENT

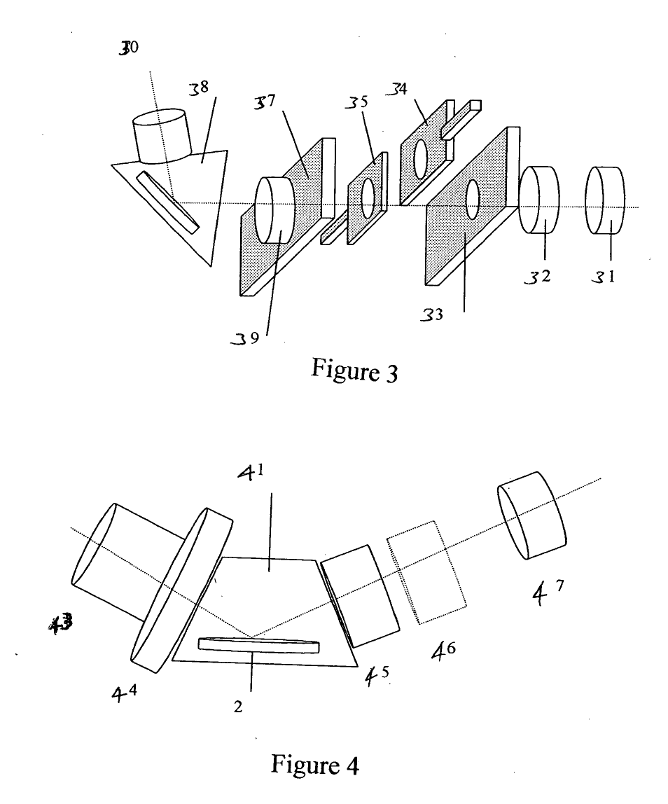

In its broadest aspect, the invention consists of a lens holder that contains at least one optic such as, but not limited to, a positive doublet of 250 mm focal length. The holder may be a rectangular housing (as shown in FIG. 3 to be described later) containing the positive lens, which holder may slide into a position placing the positive lens into the optical path of the telescope and then alternately withdrawn from the optical path of the telescope. The system of the invention thereby reduces the effective focal length of the telescope when the positive lens is introduced into the lightpath, and restoring the focal length of the telescope when the positive lens is withdrawn from the lightpath. The rectangular housing may be coupled to the rear external visual back of the telescope, a component known to those familiar in the art of amateur astronomy via a threaded coupling that matches the male threaded member of telescope visual back or may be connected by another means. It is noted that the moveable portion of the invention used for placing the lens into the lightpath and alternately removing the lens from the lightpath, may be a sliding system or a rotating system, and the invention is not limited to either and various means for accomplishing this that are known to those familiar in the art of machining and may be implemented as desired.

In another embodiment the present invention includes a means to introduce a telenegative lens in the same manner as noted above for the positive lens, in order to selectively increase the effective focal length of the telescope.

The present invention also provides a means to introduce and alternately remove optical components from a position where the optical components produce an increase or decrease in the effective focal length of a telescope, such telescope being, but not limited to a Schmidt Cassegrain, Maksutov Cassagrain, or Refractor design (i.e: any telescope design that will function with the invention).

The present invention also provides a means to allow existing 90 degree or other varying angled star diagonals to accept the invention, and in preferred embodiments in accordance with this aspect of the invention, a star diagonal that has the invention integrated therewith.

Even furthermore, the present invention is particularly well suited to adapt a binocular viewer to the eyepiece side of the lens changing system. As used herein, binocular viewer is one such as well know and currently available from Denkmeier Optical, located in Berlin, Md.

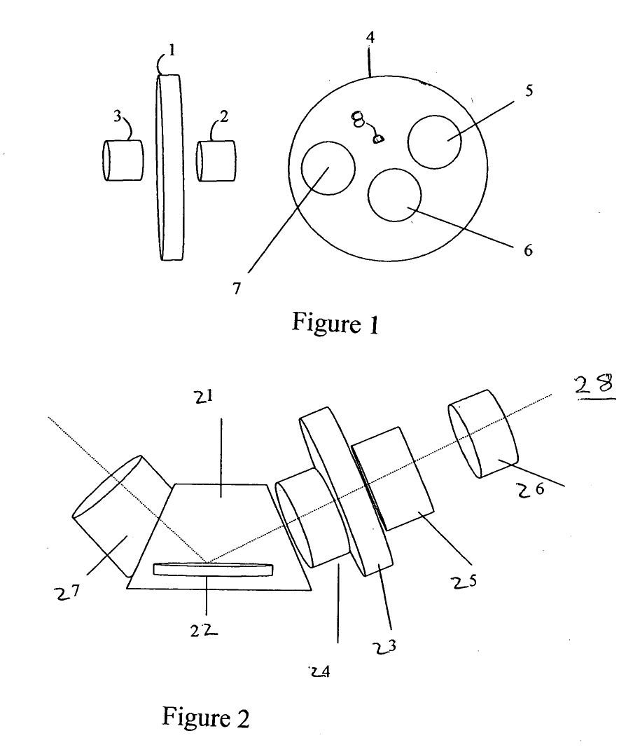

More specifically, FIG. 1 generally illustrates one way to embody an optical system in accordance with the principles of the invention, and in this example comprises a circular housing 1 with an internal area adapted to accommodate a rotating circular disc 4. Disc 4 contains a clear aperture 5 as well as at least one additional aperture 6 that houses an optical lens such as a positive lens that will produce focal reduction in a telescope. Disc 4 can also include a further aperture 7 that houses a negative lens that will increase the effective focal length of a telescope. The disc 4 is adapted for rotation within the circular housing 1 via any suitable means, such as, but not limited to, a shaft 8 that will allow each of apertures 5, 6, and 7 to be selectively aligned in the path of the light cone produced by the telescope, so that the effect of magnification increase, magnification reduction, or an absence of either (normal power as produced by an eyepiece being utilized with the telescope) will be the result. The circular housing 1 containing rotating internal disc 4 may be coupled to a telescope focuser or a star diagonal used with the telescope, by a means such as, but not limited to, a threaded hollow cylinder 2 and an eyepiece or a star diagonal may be utilized on the opposite side (the left side of FIG. 1) when coupled to an addition cylinder 3 or attached by another suitable means.

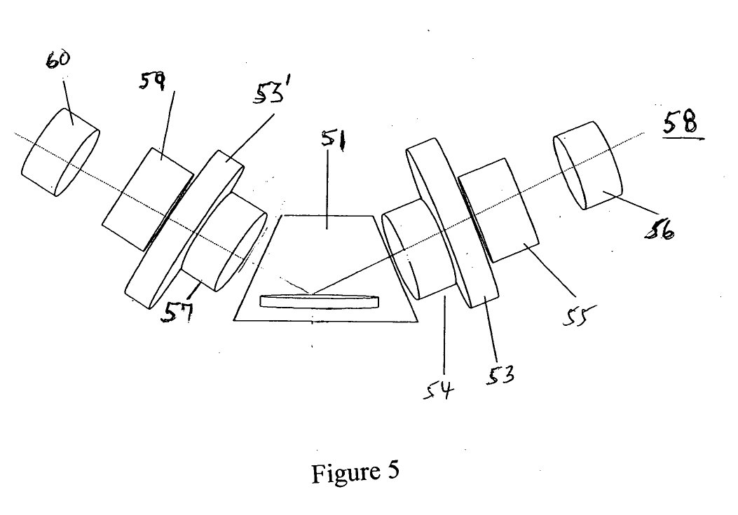

FIG. 2 illustrates a further embodiment of an optical system in accordance with the principles of the invention where the optical system of FIG. 1 is integrated with a star diagonal of the type conventionally used with a telescope. A star diagonal housing 21 containing a flat reflective mirror 22 is shown coupled to a lens changing system 23 of the type shown in FIG. 1 using a means such as, but not limited to, a threaded male hollow cylinder 24 with external threads that interface with female threads of the star diagonal housing 21. Alternatively, 23 can thread directly into housing 21 (such as shown on the eyepiece side of the diagonal 41 in FIG. 4 described below). The opposite side of the lens changing system 23 is coupled to the focuser 26 of the telescope by a means such as, but not limited to, a slip fit or threaded cylinder 25, so that a light cone produced by a telescope 28 may pass through the clear aperture or an aperture containing a positive or negative lens contained within lens changing system 23. As a result thereof, an eyepiece (not shown on the left side of FIG. 2) placed in the star diagonal housing 21 via a means such as, but not limited to, a hollow cylindrical receptacle 27, will operate at varying magnifications as the apertures within the lens changing system 23 are alternately placed in a position that is coincident with the optical light path produced by the telescope and then alternately removed.

FIG. 3 illustrates a variation of the inventive optical system shown in FIG. 1, embodied in a rectangular housing instead of a circular housing. A rectangular housing consisting of two halves 33 and 37 contain therebetween one or more sliding lens carriers 34 and 35 which contain a positive or negative optical component, respectively, so that one or more optical components may be placed in a position that is coincident with the optical path 30 of a telescope so that the effective focal length of the telescope is increased or decreased, and the rectangular assembly 37, 35, 34, 33 is coupled to a telescope focuser 31 by, but not limited to, a means such as a threaded cylinder 32. An opposite end of the rectangular housing 37 may be coupled to a single eyepiece or a Star Diagonal 38 by, but not limited to, a means such as a threaded hollow cylinder 39. Alternatively, 37 can include a threaded portion that threads directly into housing 38 (such as shown on the eyepiece side of the diagonal 41 in FIG. 4 described below) This embodiment is particularly useful for providing varying magnification (including reductions) in SCT;s with single eyepieces.

In another embodiment, the rectangular housing may alternatively be place on the opposite side, i.e., eyepiece-side, of the start diagonal 38.

FIG. 4 illustrates integration of the lens changing system of the invention on the eyepiece-side of a star diagonal. More specifically, as shown in FIG. 4, a star diagonal housing 41 has the housing 44 of lens changing system of the invention integrated with, i.e., it is coupled, for example by use of a low profile threaded element (not specifically shown), directly into the eyepiece-side of the star diagonal 41. This direct coupling is not intended to be removed by the user of the invention, since housing 44 includes the user adjustable portion. An eyepiece receptacle 43 of conventional design, couples the user's eyepiece (not specifically shown) to the eyepiece side of housing 44. A coupling, such as a threaded cylinder 45 couples the telescope side of the star diagonal 41 to the focuser receptacle 47 of the telescope, and if needed (as will described below for Refractor-type telescopes), to a negative lens 46 (shown in dashed lines), which in turn couples coupler 45 to receptacle 47. The diagonal of FIG. 4 (without lens 46) is primarily for use with SCTs using binocular viewers, but will also operate with single eyepieces, although focal reduction is not as great when used with a single eyepiece in comparison to reduction with the embodiment shown in FIG. 2. The FIG. 4 embodiment may allow three magnifications when used with a binocular viewer in an SCT or Maksutov, as well as other related telescope designs, and three magnifications when used with any single eyepiece, and it will allow binocular viewer use in a refractor-type telescope with addition of lens 46.

For some SCTs, a dovetail connector may be needed in order to reach focus in reduction mode when using a binocular viewer. The dovetail connector is a low-profile threaded cylinder, or other similar connecting member, adapted to allow one to connect a binocular viewer directly to the lens changing mechanism of the invention, thereby bypassing the conventionally used eyepiece holder, which if used, would have positioned the binocular viewer further away from the star diagonal.

As noted above, the star diagonal arrangement of FIG. 4 includes a housing 46 for a negative lens, if needed, that threads directly into the telescope-side of the diagonal housing. The negative lens allows the eyepiece-side lens changer 44 to function when using a binocular viewer with a Refractor-type telescope. Even furthermore, when using a binocular viewer, a dovetail connector as described above will allow the user to change the focusing range to suit a particular Refractor-type telescope.

FIG. 5 illustrates an even further embodiment of the invention where the lens switching arrangement of the invention is incorporate at both the eyepiece and telescope side of a star diagonal housing. This arrangement is primarily useful for refractor type telescopes using single eyepieces or binocular viewers, and provides a wide range of magnification change, from reduction to magnification. This arrangement can also be used with F/10 SCT's. More specifically, FIG. 5 shows a star diagonal housing 51 coupled to a lens changing system 53 of the type shown in FIG. 2 using a means such as, but not limited to, a threaded male hollow cylinder 54 with external threads that interface with female threads of the star diagonal housing 51. The opposite side of the lens changing system 53 is coupled to the focuser 56 of the telescope by a means such as, but not limited to, a slip fit or threaded cylinder 55, so that a light cone produced by a telescope 58 (not specifically shown) may pass through the clear aperture or an aperture containing a positive or negative lens contained within lens changing system 53. A similar lens changing system 53′ is coupled to the eyepiece side of the star diagonal housing 51, via a means such as, but not limited to, a hollow cylindrical receptacle 57. The opposite side of the lens changing system 53′ is coupled to an eyepiece by a means such as, but not limited to, a slip fit or threaded cylinder 60, so that a light cone produced by a telescope 58 (not specifically shown) may pass through the clear aperture or an aperture containing a positive or negative lens contained within lens changing system 53′. As a result, the FIG. 5 apparatus will operate at varying magnifications as the apertures within the lens changing systems 53 and 53′ are alternately placed in a position that is coincident with the optical light path produced by the telescope and then alternately removed.

It should be noted that although a user supplied eyepiece or binocular viewer is shown in the foregoing embodiments of the invention, it is not necessary that the remote viewing device be an eyepiece or binocular viewer, and in fact other remote viewing devices are possible, such as a camera.

As also noted above, for making the couplings between the various housing and components of the invention, conventional coupling techniques may be used, such as appropriately matched sets of male and female threads as described above. Position locking, if needed, can be accomplished by using a threaded locking ring, or a set screw.

While the present invention has been disclosed with reference to certain embodiments and variations, numerous other modifications, alterations and changes to the described embodiments are possible without departing from the sphere and scope of the present invention.

Accordingly, it is intended that the present invention not be limited to the described embodiments, but that it has the full scope defined by the above language, as shown in the figures, and as described in the claims which follow, as well as equivalents thereof.

1. An optical system for changing the focal length of a telescope, comprising:
a housing having first and second opposed ends, said housing having a lightpath passing through said first and second ends, which lightpath is adapted to be positioned in alignment with the lightpath of the telescope,
said housing including therein a moveable portion for selectively positioning into and out of the lightpath passing through the housing at least one optical element, wherein the selective positioning of said optical element into the lightpath changes the effective focal length of the telescope, and
one of said first and second ends of said housing is adapted to be coupled to said telescope so as to receive the lightpath created thereby, and the other of said first and second ends of said housing is adapted to be coupled to a viewing device of the telescope user.

2. The optical system of claim 1, wherein the viewing device is an eyepiece.

3. The optical system of claim 1, wherein the viewing device is a camera.

4. The optical system of claim 1, wherein the viewing device is a binocular viewer.

5. The optical system of claim 1, wherein the moveable portion includes as the optical element at least one of a positive lens or a negative lens, for putting in or taking out of the lightpath the optical element.

6. The optical system of claim 1, wherein the first end of the housing is coupled to a focuser tube portion of the telescope, and the second end of the housing is coupled to a star diagonal.

7. The optical system of claim 1, wherein the first end of the housing is coupled to a star diagonal of the telescope, and the second end of the housing is coupled to the viewing device.

8. The optical system of claim 7, wherein the viewing device is a binocular viewer.

9. The optical system of claim 1, wherein the viewing device is an eyepiece.

10. The optical system of claim 8, wherein a low-profile connector couples the binocular viewer to the star diagonal.

11. A star diagonal for use in a lightpath created by a telescope, comprising:
a housing, said housing having opposed first and second ends with openings therein for passing a lightpath therethrough and a mirror positioned therebetween in a manner so as to bend the lightpath passing between the opposed first and second ends,
one of said first and second ends of the housing having a coupling means aligned with the lightpath for directly attaching to the housing in a manner that is not intended to be removable by a user of the star diagonal, a movable portion for selectively positioning into and out of the lightpath passing through the housing at least one optical element, wherein the selective positioning of said optical element into and out of the lightpath changes the effective focal length of the telescope, and
the other of said first and second ends of the housing having a coupling means aligned with the lightpath which is adapted for allowing a user of the star diagonal to couple said other end to a portion of the telescope.

12. The star diagonal of claim 11, wherein the first end of the star diagonal is coupled to intercept the lightpath provided from the telescope, and the second end is coupled to an optical device through which the user of the telescope can view an image created by the lightpath.

13. The star diagonal of claim 11, wherein the optical device used to view the image is an eyepiece of the telescope.

14. The star diagonal of claim 11, wherein the optical device used to view the image is a binocular viewer.

15. The star diagonal of claim 14, wherein a low-profile dovetail connector is used to connect the binocular viewer to the eyepiece side of the star diagonal, thereby avoiding the use of a conventional eyepiece receptacle, and positioning the binocular viewer closer to the star diagonal, creating thereby more backfocus than if a said dovetail connector was not low profile.

16. The star diagonal of claim 11, wherein the movable element selectively positions in the lightpath at least one of a + optical element, a − optical element, or no optical element.

17. The star diagonal of claim 11, wherein the second end of the housing is coupled to intercept the lightpath provided from the telescope, and the first end of the housing is coupled to an optical device through which the user of the telescope can view an image created by the lightpath.

18. The star diagonal of claim 17, wherein the moveable portion includes as the optical element at least one of a positive lens or a negative lens, for putting in or taking out of the lightpath the optical element.

19. The star diagonal of claim 11, wherein both of said first and second ends of the housing have a coupling means aligned with the lightpath for directly attaching to the housing in a manner that is not intended to be removable by a user of the star diagonal, said movable element.

20. The star diagonal of claim 19, wherein the moveable portion includes as the optical element at least one of a positive lens or a negative lens, for putting in or taking out of the lightpath the optical element.
